(19) United States
(12) Patent Application Publication
(10) Pub. No.: US 2017/0269709 A1
(43) Pub. Date: Sep. 21, 2017

(54) APPARATUS, METHOD FOR IMAGE PROCESSING, AND NON-TRANSITORY MEDIUM STORING PROGRAM

(71) Applicant: FUJITSU LIMITED, KAWASAKI-SHI (JP)

(72) Inventors: KOICHI YAMASAKI, KAWASAKI (JP); RYO MIYAMOTO, KAWASAKI (JP); KAZUKI MATSUI, KAWASAKI (JP)

(73) Assignee: FUJITSU LIMITED, KAWASAKI-SHI (JP)

(21) Appl. No.: 15/426,405

(22) Filed: Feb. 7, 2017

(30) Foreign Application Priority Data
Mar. 15, 2016 (JP) 2016-051663

(51) Int. Cl. G06F 3/038; H04N 19/17; G06T 7/136; H04N 19/51; G06F 3/0354; G06T 7/246

(52) U.S. Cl. CPC G06F 3/038; G06F 3/03543; G06T 7/248; G06T 7/136; H04N 19/51; H04N 19/17; H04L 67/42

(57) ABSTRACT

An apparatus for image processing includes: a memory for storing display screen data to be displayed on a display device; and a processor configured to acquire a position of a pointer of an input device, update the display screen data, identify a region updated at an update frequency larger than a threshold between frames of the display screen data, search, based on a track of the position of the pointer, for a motion direction of the identified region, segment the identified region into segments along a border line set therein according to the motion direction, and execute a compression process that includes assigning processes for performing video compression on images of the segments of the region to a plurality of processors, respectively, and causing the plurality of processors to perform the video compression processes in parallel.

### CROSS-REFERENCE TO RELATED APPLICATION

This application is based upon and claims the benefit of priority of the prior Japanese Patent Application No. 2016-051663, filed on Mar. 15, 2016, the entire contents of which are incorporated herein by reference.

### FIELD

The embodiments discussed herein are related to an apparatus, a method for image processing, and a non-transitory medium storing a program.

### BACKGROUND

A system called a thin client system is known. A thin client system is built such that a server manages resources such as applications and files, while a client is given minimum functions. In such a thin client system, a client terminal behaves as if the client terminal itself primarily executed processing and retained data, although the client terminal is in fact only displaying a result of processing executed by a server device or data retained by the server device.

For example, the thin client system causes the server device to execute a business application, such as document creation or emailing, and causes the client terminal to display a result of the processing by the application. The thin client system is expanding its range of application more and more to include, besides the foregoing business application, an application that handles fine still images, such as computer-aided design (CAD), and furthermore, an application that handles videos.

When data to be displayed on the desktop screen (desktop screen data) is transmitted from a server device to a client terminal, the bandwidth of a network connecting the server device and the client terminal and the amount of the data transmitted over the network may become a bottleneck in the data transmission and therefore cause transmission delay. Such transmission delay causes delay in rendering of the desktop screen data transmitted from the server device to the client terminal onto the client terminal, and consequently poor response to operation on the client terminal.

As an example of avoiding such transmission delay, a hybrid method has been proposed, in which among differential updated regions on the desktop screen, a frequently updated region is converted into a video, while the rest is transmitted as still images.

As examples of the related art, International Publication Pamphlet Nos. WO 2014/080440 and WO 2009/102011 and Japanese Laid-open Patent Publication No. 2012-119945 are known.

### SUMMARY

According to an aspect of the invention, an apparatus for image processing includes: a memory configured to store display screen data to be displayed on a display device; and a processor coupled to the memory and configured to execute an acquisition process that includes acquiring a position of a pointer of an input device, execute an update process that includes updating the display screen data stored in the memory, execute an identifying process that includes identifying a region updated at an update frequency equal to or larger than a threshold between frames of the display screen data stored in the memory, execute a search process that includes, based on a track of the position of the pointer, searching for a motion direction of the region updated at the update frequency equal to or larger than the threshold, execute a segmentation process that includes segmenting the region updated at the update frequency equal to or larger than the threshold into segments along a border line set therein according to the motion direction, and execute a compression process that includes assigning a plurality of processes for performing video compression on images of the segments of the region to a plurality of processors, respectively, and causing the plurality of processors to perform the video compression processes in parallel.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating the functional configurations of devices included in a thin client system according to Embodiment 1;

FIG. 2 illustrates an example of a desktop screen;

FIG. 3A is a diagram illustrating an example of how to calculate a motion vector;

FIG. 3B is a diagram illustrating the example of how to calculate a motion vector;

FIG. 3C is a diagram illustrating the example of how to calculate a motion vector;

FIG. 4 is a diagram illustrating an example of a desktop screen;

FIG. 5 is a diagram illustrating an example of a desktop screen;

FIG. 6 is a diagram illustrating an example of a desktop screen;

FIG. 7 is a diagram illustrating an example of a desktop screen;

FIG. 8 is a diagram illustrating an example of a desktop screen;

FIG. 9 is a flowchart (1) illustrating procedures of segmentation processing according to Embodiment 1;

FIG. 10 is a flowchart (2) illustrating procedures of the segmentation processing according to Embodiment 1;

FIG. 11 is a flowchart illustrating procedures of first transmission control processing according to Embodiment 1;

FIG. 12 is a flowchart illustrating procedures of second transmission control processing according to Embodiment 1; and

FIG. 13 is a diagram illustrating an example of the hardware configuration of a computer executing a transmission program according to Embodiments 1 and 2.

### DESCRIPTION OF EMBODIMENTS

In a thin client system, the spread of high-definition displays such as 2K and 4K displays is thought to increase the amount of data to be processed by a server device for video compression coding and the amount of data to be transmitted by the server device to a client terminal after the video compression coding.

For this reason, a conventional hybrid method may use multiple central processing unit (CPU) cores for respective small segments of a region to be converted into a video (hereinafter called a video conversion region), so that video compression coding may be performed on the small segments by the CPU cores in parallel.

This technique, however, may lower the compression efficiency for the video conversion region on the desktop screen for the following reason.

Video compression coding may be performed more efficiently when inter-frame prediction is used. In inter-frame prediction, motion compensation is performed through motion vector search (motion estimation (ME)). However, when a video conversion region is segmented on the desktop screen, the motion compensation may not function effectively depending on the direction in which the region is segmented. For example, if a video conversion region on the desktop screen is segmented in a direction orthogonal to a motion vector which would be detected if the video conversion region on the desktop screen were not segmented, the segmentation may make it impossible to detect the motion vector. As a result, compression efficiency decreases.

As one aspect of the present embodiment, provided are solutions for being able to avoid decrease in video compression efficiency.

With reference to the attached drawings, a description is given below of an apparatus, a method, and a non-transitory medium storing a program for image processing according to the present application. The following embodiments are not provided to limit the techniques disclosed herein and may be combined appropriately as long as such a combination does not cause any conflict in the processing steps.

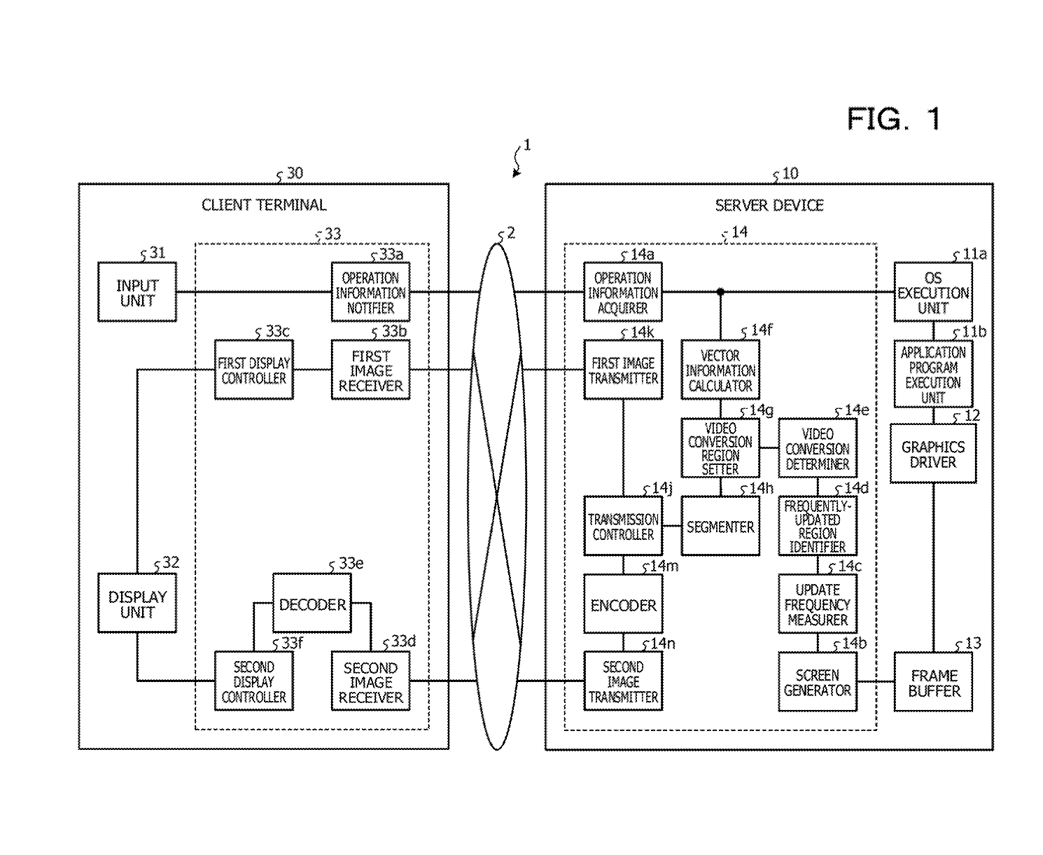

### Embodiment 1

<System Configuration> FIG. 1 is a block diagram illustrating the functional configurations of devices included in a thin client system according to Embodiment 1. A thin client system 1 illustrated in FIG. 1 causes a server device 10 to remotely control a desktop screen displayed on a client terminal 30. In other words, in the thin client system 1, the client terminal 30 behaves as if the client terminal 30 itself primarily executed processing or retained data when the client terminal 30 is in fact just displaying a result of processing executed by the server device 10 or data retained by the server device 10. The server device 10 is an example of the apparatus for image processing according to the present application. The apparatus for image processing may be called as an image processing device.

As illustrated in FIG. 1, the thin client system 1 includes the server device 10 and the client terminal 30. Although FIG. 1 illustrates an example where one client terminal is connected to one server device 10, more than one client terminal may be connected to one server device 10. In other words, the thin client system 1 may be implemented using server-based computing, blade PCs, virtual desktop infrastructure (VDI), or any other method.

The server device 10 and the client terminal 30 are communicatively connected to each other via a network 2. The network 2 may be either wired or wireless, and may be the Internet, a local region network (LAN), a virtual private network (VPN), or any other communication network. The following assumes as an example that the remote framebuffer (RFB) protocol used in virtual network computing (VNC) is employed as the protocol for communications between the server device 10 and the client terminal 30.

The server device 10 is a computer that provides a remote screen control service, that is, the server device 10 remotely controls the desktop screen displayed on the client terminal 30. A remote screen control application for server is installed or preinstalled in the server device 10. Hereinafter, the remote screen control application for server may be called a “server-side remote screen control app”.

The basic function of this server-side remote screen control app is to provide a remote screen control service. For example, the server-side remote screen control app acquires information on operation on the client terminal 30 and then causes an operating system (OS) or another application running on the server device 10 to execute processing requested by that operation. Thereafter, the server-side remote screen control app generates a desktop screen updated according to a result of the processing executed by the OS or application, and then transmits data for displaying the thus-generated desktop screen to the client terminal 30. Here, the server-side remote screen control app may not transmit an image of the entire desktop screen to the client terminal 30. Specifically, the server-side remote screen control app transmits an image of an updated region, which is a region concentratedly containing pixels that are updated from a bitmap image displayed before the current desktop screen update. Although the image of the updated region is rectangular as an example in the following description, any shape other than the rectangle, such as a polygon or an oval, may also be used.

The server-side remote screen control app also has a function to specify a part that is frequently updated between frames by which the desktop screen is updated, compress data on the aforementioned part using a compression format for video, and transmit the compressed data to the client terminal 30. For example, the server-side remote screen control app monitors the frequency of inter-frame update for each segment of the desktop screen, which is segmented in a mesh form. Then, the server-side remote screen control app specifies a segment updated at a frequency exceeding a threshold as a frequently-updated region, and transmits attribute information on the frequently-updated region to the client terminal 30. In addition, the server-side remote screen control app encodes bitmap images of the frequently-updated region into data in the Moving Picture Experts Group (MPEG) format, such as MPEG-2 or MPEG-4, and transmits the encoded data to the client terminal 30. Although the data is compressed in the MPEG format herein, the embodiments are not limited to this. Any compression coding scheme for video may be employed, such as, for example, the Motion Joint Photographic Experts Group (M-JPEG) format.

The client terminal 30 is a computer that receives the remote screen control service provided by the server device 10.

In one embodiment, the client terminal 30 may be a fixed terminal, such as a personal computer, or a mobile terminal, such as a mobile phone, a personal handy-phone system (PHS), or a personal digital assistant (PDA). A remote screen control application for client is installed or preinstalled in the client terminal 30. Hereinafter, the remote screen control application for client may be called a “client-side remote screen control app”.

This client-side remote screen control app has a function to upload, to the server device 10, operation information received via any of various types of input devices, such as a mouse or a keyboard. As the operation information, the client-side remote screen control app notifies the server device 10 of, for instance, a mouse event, such as a right click, a left click, a double click, or a drag, the position of the cursor of the mouse on the desktop screen, the amount of rotation of the mouse wheel, and the like. Although the operation information is regarding the mouse herein, the operation information uploaded by the client terminal 30 may be regarding to operation on other input devices such as a keyboard. In such a case, the operation information may be, for example, the type of a key pressed on the keyboard.

The client-side remote screen control app also has a function to cause a predetermined display unit to display an image transmitted from the server device 10. In an example, when receiving a bitmap image of an updated region from the server device 10, the client-side remote screen control app displays the image of the updated region at a position having an update from the previous bitmap image. In another example, when receiving attribute information on a frequently-updated region from the server device 10, the client-side remote screen control app sets a region on the desktop screen that corresponds to the position indicated by the attributed information, as a blank region where no bitmap image is to be displayed. Then, when receiving data in a compression format for video, the client-side remote screen control app decodes the data and plays the video on the blank region.

<Configuration of the Server Device> Next, the configuration of the server device 10 according to the present embodiment is described. As illustrated in FIG. 1, the server device 10 includes an operating system (OS) execution unit 11a, an application program execution unit 11b, a graphics driver 12, a framebuffer 13, and a server-side remote screen control unit 14. The server device 10 in the example illustrated in FIG. 1 further includes, besides the function units illustrated in FIG. 1, various other function units that a known computer has, for example, an interface for communications control such as a network interface card.

The OS execution unit 11a is a processor that controls operation of an OS, which is the basic software.

In one embodiment, the OS execution unit 11a detects an instruction to activate an application or a command to a running application, in operation information acquired by an operation information acquirer 14a to be described later. For example, upon detection of a double click with the position of the mouse cursor located over an icon corresponding to a certain application, the OS execution unit 11a instructs the application program execution unit 11b to be described below to activate the certain application. In another example, when detecting that operation requesting execution of a command is performed on an operation screen, that is, a window, of a running application, the OS execution unit 11a instructs the application program execution unit 11b to execute the command.

The application program execution unit 11b is a processor that controls operation of an application as instructed by the OS execution unit 11a.

In one embodiment, when instructed by the OS execution unit 11a to activate an application or to execute a command to a running application, the application program execution unit 11b operates the application accordingly. The application program execution unit 11b then requests the graphics driver 12 to be described below to rasterize, to the framebuffer 13, a display image representing a processing result obtained by the execution of the application. When thus requesting the graphics driver 12 to rasterize the display image, the application program execution unit 11b notifies the graphics driver 12 of the display image as well as the position on the framebuffer 13 to rasterize the display image.

The application executed by the application program execution unit 11b may be preinstalled or installed after the server device 10 is shipped, or may be an application that runs on a network platform such as Java (registered trademark).

The graphics driver 12 is a processor that rasterizes images to the framebuffer 13.

In one embodiment, upon reception of a rasterization request from the application program execution unit 11b, the graphics driver 12 rasterizes a display image representing a processing result obtained by an application, the display image being generated in a bitmap format at a rasterization position on the framebuffer 13 designated by the application. Although the graphics driver 12 receives the rasterization request from the application program execution unit 11b herein as an example, the graphics driver 12 may receive the rasterization request from the OS execution unit 11a, instead. For example, upon reception of a rasterization request for a mouse cursor from the OS execution unit 11a, the graphics driver 12 generates a display image of the mouse cursor in a bitmap format at a rasterization position on the framebuffer 13 designated by the OS.

The framebuffer 13 is a storage device that stores bitmap data generated by the graphics driver 12.

In one embodiment, the framebuffer 13 may be a semiconductor memory device such as a RAM, including a video random access memory (VRAM), or a flash memory. The framebuffer 13 does not have to be a semiconductor memory device, but may alternatively be an auxiliary storage device such as a hard disk driver (HDD), an optical disk, or a solid state drive (SSD).

The server-side remote screen control unit 14 is a processor that provides the client terminal 30 with a remote screen control service via the server-side remote screen control app. As illustrated in FIG. 1, the server-side remote screen control unit 14 includes the operation information acquirer 14a, a screen generator 14b, an update frequency measurer 14c, a frequently-updated region identifier 14d, a video conversion determiner 14e, a vector information calculator 14f, a video conversion region setter 14g, a segmenter 14h, a transmission controller 14j, an encoder 14m, a first image transmitter 14k, and a second image transmitter 14n.

The operation information acquirer 14a is a processor that acquires operation information from the client terminal 30.

In one embodiment, examples of the operation information that the operation information acquirer 14a may acquire from the client terminal 30 include information on mouse operation, information on keyboard operation, and the like. Examples of the information on mouse operation acquirable by the operation information acquirer 14a include a right click, a left click, a double click, a drag, the position of the mouse cursor on the desktop screen, the amount of rotation of the mouse wheel, and the like. Examples of the information on keyboard operation acquirable by the operation information acquirer 14a include an action of pressing a key, or keys in combination, on the keyboard, the keys including an alphabet key, a function key, a Ctrl key, a Shift key, a number key, and the like.

The screen generator 14b is a processor that generates an image of a desktop screen to be displayed on a display unit 32 of the client terminal 30.

In one embodiment, the screen generator 14b starts the following processing every time a period for updating the desktop screen, for example, 30 fps, elapses. Hereinafter, the period for updating the desktop screen to be displayed on the client terminal 30 is called a “screen update period”. The screen update period may have any length determined depending on factors such as the bandwidth between the server device 10 and the client terminal 30, the capabilities of the server device 10 and the client terminal 30, and the like. For example, the screen generator 14b generates a desktop screen image as follows. First, the screen generator 14b refers to the framebuffer 13 and an internal memory (not illustrated) that retains bitmap data on an entire desktop screen which has been most recently transmitted from the server device 10 to the client terminal 30. The screen generator 14b then extracts pixels that differ in pixel values between the bitmap data on the desktop screen retained by the internal memory and bitmap data on the desktop screen stored in the framebuffer 13. Then, the screen generator 14b performs labeling on the pixels thus extracted, forms a rectangular blob containing pixels with the same label as an updated region, and thus generates a packet of the updated region. The screen generator 14b adds, to each updated region, attribute information by which the position and size of the updated region are identifiable, for example, the coordinates of the upper left vertex of the updated region and the height and width of the updated region.

The update frequency measurer 14c is a processor that measures the inter-frame update frequency of each of segments into which the desktop screen is segmented.

In one embodiment, the update frequency measurer 14c measures the update frequency of each of mesh segments obtained by segmentation of the desktop screen in a mesh form. The update frequency measurement uses, in one example, an update count map which represents correspondences between the mesh segments of the desktop screen and the numbers of times of update (update counts) of the mesh segments. The “number of times of update” herein indicates, in one example, the number of times a segment is updated over the past predetermined N frames (where N is a natural number). For example, the update frequency measurer 14c performs the following processing every time the above-described screen update period elapses. Specifically, the update frequency measurer 14c discards the oldest measurement results from the update count map by decrementing, in the update count map, the update count for a segment whose update count has been incremented N frames ago. Thereafter, for each updated region generated by the screen generator 14b, the update frequency measurer 14c detects mesh segments overlapping with a plane defined by the attribute information on the updated region. Then, in the update count map, the update frequency measurer 14c increments the update count of each mesh segment with which a predetermined number (for example, 1) or more of updated regions overlap.

The frequently-updated region identifier 14d is a processor that identifies a region within the desktop screen which is updated at a high frequency, as a frequently-updated region.

In one embodiment, every time the screen update period elapses, the frequently-updated region identifier 14d identifies a frequently-updated region using the update count map. For example, from the mesh segments in the update count map, the frequently-updated region identifier 14d extracts segments the update count for which exceeds a predetermined threshold. The frequently-updated region identifier 14d then performs labeling on the segments extracted as segments with an update count exceeding the predetermined threshold, forms a blob containing segments with the same label, and identifies the blob as a “frequently-updated region”. A blob of segments thus identified as the frequently-updated region herein as an example may have a predetermined shape such as a rectangle. In addition, blobs within a predetermined distance may be combined and enclosed by a bounding box, and the bounding box may be identified as the frequently-updated region.

The video conversion determiner 14e is a processor that determines whether to perform video conversion.

In one embodiment, after every predetermined M frames (where M is a natural number), the video conversion determiner 14e determines whether a frequently-updated region has been identified by the frequently-updated region identifier 14d. When a frequently-updated region has been identified, a current frame t is assumed to be in a situation where, for example, a model rendered using three-dimensional computer graphics (3DCG), such as a computer-aided design (CAD) model or a computer-aided engineering analysis model, has been moved by a mouse event such as a drag-and-drop operation. Other possible situations include a window of any of various types having been moved by a mouse event, or a video being played on the client terminal 30. When there is a frequently-updated region on the desktop screen, video conversion is performed. On the other hand, when no frequently-updated region is identified, it may be estimated that a frequently-updated region is unlikely to be present on the desktop screen. Then, no video conversion is performed.

A vector information calculator 14f is a processor that calculates vector information on a mouse cursor.

In one aspect, if M frames have not elapsed yet since the last video conversion determination by the video conversion determiner 14e, or if the video conversion determiner 14e determines not to perform video conversion, the vector information calculator 14f saves, in a work area of the internal memory, the coordinates of the mouse cursor in the current frame t, acquired by the operation information acquirer 14a. Saving the coordinates of the mouse cursor in the current frame tin the internal memory allows, in a certain frame in which a video conversion determination is made, reference to be made to the coordinates of the mouse cursor in a frame which is one frame prior to the certain frame (hereinafter called a previous frame).

In another aspect, the vector information calculator 14f performs the following processing when the video conversion determiner 14e determines to perform video conversion. Specifically, the vector information calculator 14f reads the coordinates of the mouse cursor in a previous frame t−1 saved in the internal memory. Then, based on the coordinates of the mouse cursor in the previous frame t−1 read from the internal memory and the coordinates of the mouse cursor in the current frame t acquired by the operation information acquirer 14a, the vector information calculator 14f calculates the direction and amount of motion of the mouse cursor, as vector information.

The video conversion region setter 14g is a processor that sets a region to be converted into a video on the desktop screen.

In one aspect, the video conversion region setter 14g performs the following processing if M frames have not elapsed yet since the last video conversion determination by the video conversion determiner 14e, or if the video conversion determiner 14e determines not to perform video conversion. Specifically, the video conversion region setter 14g saves, in the work area of the internal memory, attribute information on the frequently-updated region in the current frame t identified by the frequently-updated region identifier 14d. The attribute information defines the position, shape, and size of the frequently-updated region, and includes, for example, the coordinates of each vertex forming the frequently-updated region. Saving the attribute information on the frequently-updated region in the current frame t in the internal memory allows, in a certain frame in which a video conversion determination is made, reference to be made to the attribute information on a frequently-updated region in the previous frame of the certain frame. Although the attribute information on a frequently-updated region is the coordinates of each vertex forming the frequently-updated region in the example described above, the attribute information may alternatively be, if the frequently-updated region is rectangular, the coordinates of the upper left vertex of the frequently-updated region and the width and height of the frequently-updated region.

In another aspect, the video conversion region setter 14g performs the following processing when the video conversion determiner 14e determines to perform video conversion. Specifically, the video conversion region setter 14g reads attribute information on the frequently-updated region in the previous frame t−1 saved in the internal memory. Then, using the vector information on the mouse cursor calculated by the vector information calculator 14f, the video conversion region setter 14g searches for a frequently-updated region in the current frame t identified by the frequently-updated region identifier 14d, which is similar in shape to the frequently-updated region in the previous frame t−1 read from the internal memory.

When successfully finding the frequently-updated region similar in shape between the previous frame t−1 and the current frame t, the video conversion region setter 14g determines the direction and distance from the frequently-updated region in the previous frame t−1 to the frequently-updated region in the current frame t as a motion vector between the frames. When failing to find the frequently-updated region similar in shape between the previous frame t−1 and the current frame t, the video conversion region setter 14g sets the motion vector between the frames to empty, for example, zero.

Using the motion vector thus obtained, the video conversion region setter 14g sets a region to be converted into a video on the desktop screen for the next M frames. Hereinafter, the region to be converted into a video on the desktop screen for the next M frames may be called a “video conversion region”. The video conversion region setter 14g may set the video conversion region according to the above-described motion vector using the frequently-updated region in the current frame t as a starting point, but this frequently-updated region contains a mesh segment not updated in the current frame t by motion from the previous frame t−1. Thus, the video conversion region setter 14g may set the video conversion region by using a blob of segments which overlap with an updated region which is one of the updated regions generated by the screen generator 14b in the current frame t and which overlaps with the frequently-updated region in the current frame t by the largest area. For example, the video conversion region setter 14g sets a starting point at such an updated region in the current frame t, and sets a target direction at the motion direction defined by the motion vector. Then, the video conversion region setter 14g moves the updated region in the current frame t M times the motion distance defined by the motion vector, that is, from the current frame t to the M-th frame after which the next video conversion determination is made. The video conversion region setter 14g then sets a video conversion region at a blob of segments overlapping with at least one of the updated region in the current frame t, a predicted updated region where the updated region in the current frame t is predicted to be located in the M-th frame, or a track of the updated region in the current frame t from the current frame t to the M-th frame. If the motion vector is set to zero, the updated region in the current frame t and the predicted updated region in the M-th frame coincide with each other. Thus, in this case, the video conversion region setter 14g sets a video conversion region to the updated region in the current frame t. Attribute information on the video conversion region thus set, such as the coordinates of each vertex of the video conversion region, is outputted to the segmenter 14h to be described later.

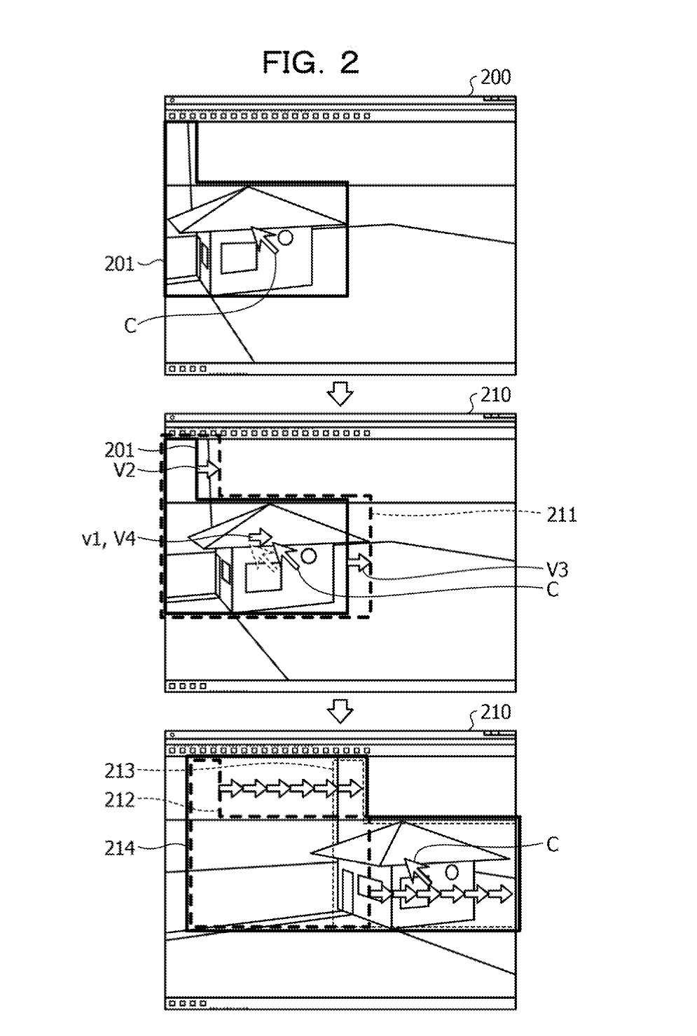

FIG. 2 is a diagram illustrating an example of a desktop screen. The upper part of FIG. 2 depicts a desktop screen 200 in the previous frame t−1 along with a frequently-updated region 201 in the previous frame t−1. The middle part of FIG. 2 depicts a desktop screen 210 in the current frame t along with a frequently-updated region 211 in the current frame t represented with a dotted line and the frequently-updated region 201 in the previous frame t−1 represented with a solid line. The lower part of FIG. 2 depicts a (predicted) screen in the M-th frame along with an updated region 212 in the current frame t represented with a (thick) broken line, a predicted updated region 213 in the M-th frame represented with a (thin) broken line, and a video conversion region 214 to be converted into a video on the desktop screen represented with a thick solid line. Reference sign C in FIG. 2 indicates the mouse cursor. FIG. 2 illustrates an example case where the period for determining whether to perform video conversion is six frames, namely, M=6.

As illustrated in the middle part of FIG. 2, the frequently-updated region 211 is identified in the current frame t, and it is determined that video conversion is performed. When it is determined to perform video conversion, the direction and distance of motion of the mouse cursor are calculated as vector information v1. It is assumed in this example that the motion direction defined by the vector information v1 is “rightward”. By reference to the motion direction and the motion distance defined by the vector information v1, the frequently-updated region 211 in the current frame t which is similar in shape to the frequently-updated region 201 in the previous frame t−1 is searched for. Then, the direction and distance of motion of the frequently-updated region 201 in the previous frame t−1 to the frequently-updated region 211 in the current frame t are calculated as a motion vector V4. In this example, the motion vector V4 is substantially the same as the vector information v1 indicating the direction and distance of motion of the mouse cursor.

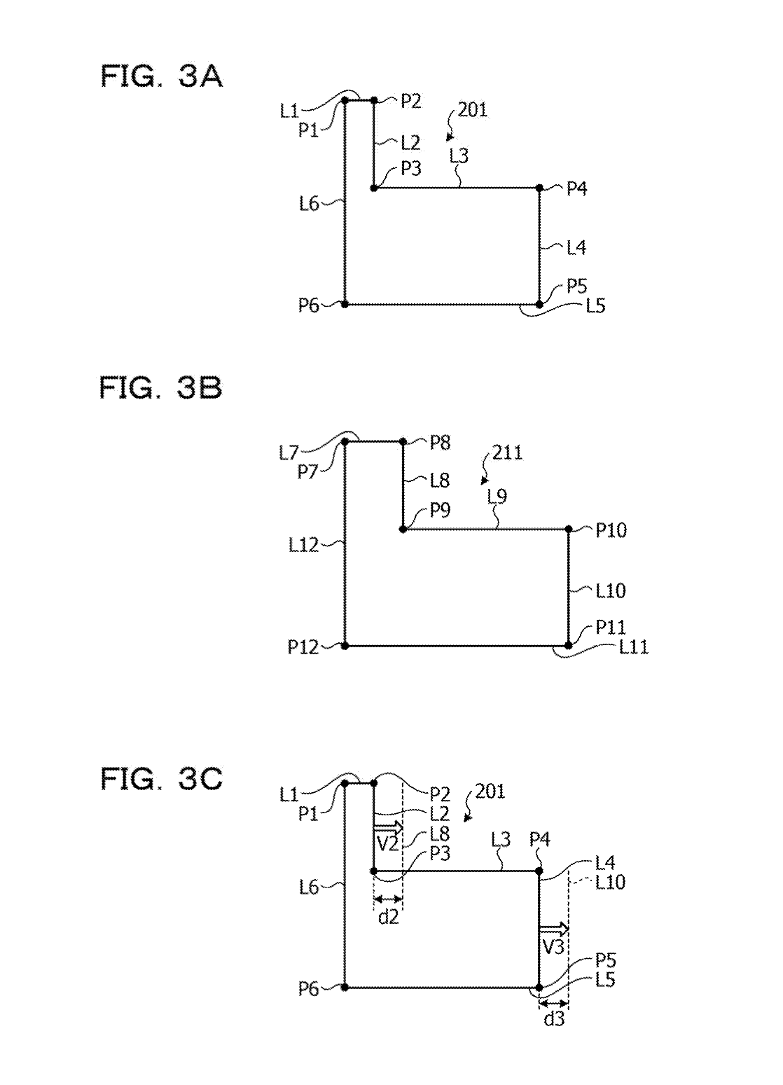

FIGS. 3A to 3C are diagrams illustrating an example of how to calculate a motion vector. FIG. 3A depicts the frequently-updated region 201 illustrated in FIG. 2, while FIG. 3B depicts the frequently-updated region 211 illustrated in FIG. 2. The following description assumes a coordinate system in which the X axis and the Y axis for an image lie in the horizontal direction and the vertical direction of the image, respectively.

A comparison is made between each horizontal line segment in the frequently-updated region 201 illustrated in FIG. 3A and a corresponding horizontal line segment in the frequently-updated region 211 illustrated in FIG. 3B. Specifically, a line segment L1 connecting a vertex P1 and a vertex P2 of the frequently-updated region 201 and a line segment L7 connecting a vertex P7 and a vertex P8 of the frequently-updated region 211 have the same Y coordinate. Further, a line segment L3 connecting a vertex P3 and a vertex P4 of the frequently-updated region 201 and a line segment L9 connecting a vertex P9 and a vertex P10 of the frequently-updated region 211 have the same Y coordinate. Further, a line segment L5 connecting a vertex P5 and a vertex P6 of the frequently-updated region 201 and a line segment L11 connecting a vertex P11 and a vertex P12 of the frequently-updated region 211 have the same Y coordinate.

Thus, it may be determined, without shifting the horizontal line segments vertically, that the number and heights of horizontal line segments are the same between the frequently-updated region 201 and the frequently-updated region 211. It may therefore be estimated that there is no vertical movement between the previous frame t−1 and the current frame t.

A comparison is made between each vertical line segment in the frequently-updated region 201 illustrated in FIG. 3A and a corresponding vertical line segment in the frequently-updated region 211 illustrated in FIG. 3B. A line segment L6 connecting the vertex P1 and the vertex P6 of the frequently-updated region 201 and a line segment L12 connecting the vertex P7 and the vertex P12 of the frequently updated region 211 coincide with each other. Meanwhile, a line segment L2 connecting the vertex P2 and the vertex P3 of the frequently-updated region 201 and a line segment L8 connecting the vertex P8 and the vertex P9 of the frequently-updated region 211 have the same Y coordinates over a section equal to or larger than a predetermined threshold, but does not have the same X coordinate. Further, a line segment L4 connecting the vertex P4 and the vertex P5 of the frequently-updated region 201 and a line segment L10 connecting the vertex P10 and the vertex P11 of the frequently-updated region 211 have the same Y coordinates over a section equal to or larger than the predetermined threshold, but does not have the same X coordinate. It may therefore be estimated that there is horizontal movement between the previous frame t−1 and the current frame t.

When it is thus estimated that there is horizontal movement, the distance of the horizontal motion of the frequently-updated region 201 from the previous frame t−1 to the current frame t is calculated. For this calculation, vertical line segments the Y coordinates of which coincide with each other over a section equal to or larger than the predetermined threshold are paired up, and the vertical line segment in the frequently-updated region 201 is moved until its X coordinate coincides with that of the vertical line segment of the frequently-updated region 211.

Specifically, as illustrated in FIG. 3C, a process of shifting the line segment L2 of the frequently-updated region 201 in a unit of a predetermined number of pixels rightward, which is the motion direction defined by the vector information v1, is repeated until the X coordinate of the line segment L2 of the frequently-updated region 201 coincides with the X coordinate of the line segment L8 of the frequently-updated region 211. A horizontal motion distance d2 of the line segment L2 is thereby calculated. Moreover, a process of shifting the line segment L4 of the frequently-updated region 201 in a unit of a predetermined number of pixels is repeated until the X coordinate of the line segment L4 of the frequently-updated region 201 coincides with the X coordinate of the line segment L10 of the frequently-updated region 211. A horizontal motion distance d3 of the line segment L4 is thereby calculated.

Two motion vectors, namely a motion vector V2 and a motion vector V3, are thus obtained. Specifically, as to the motion vector V2, the vertical motion distance is “zero” and the horizontal motion distance is “d2”, and thus the motion direction is “rightward” and the motion distance is “d2”. As to the motion vector V3, the vertical motion distance is “zero” and the horizontal motion distance is “d3”, and thus the motion direction is “rightward” and the motion distance is “d3”. A motion vector V4 representative of the two motion vectors V2 and V3 may be obtained through statistical processing such as average or median calculation.

There is no vertical motion between the previous frame t−1 and the current frame tin the example above. However, when there is vertical motion between the previous frame t−1 and the current frame t, the vertical motion distance may be obtained through the process described using FIG. 3C by changing the shift direction to the vertical direction. If the motion direction defined in the vector information v1 is neither horizontal nor vertical, reference may be made to a horizontal component and a vertical component into which the motion direction in the vector information v1 is decomposed.

Referring back to FIG. 2, after the motion vector V4 is calculated, the updated region 212 in the current frame t is set as a starting point, and the motion direction “rightward” defined by the motion vector V4 is set as a target direction, as illustrated in the lower part of FIG. 2. Then, the updated region 212 in the current frame t is moved six times the motion distance defined by the motion vector V4, for example, (d2+d3)/2 because the next determination on whether to perform video conversion is six frames away from the current frame t. The predicted updated region 213 where the updated region 212 is predicted to be located after six frames is thereby obtained. Then, a blob of segments that overlap with at least one of the updated region 212, the predicted updated region 213, and the track of the updated region 212 moving from the current frame t to the M-th frame is set as the video conversion region 214.

When the video conversion region is thus set, a range over which update frequency is predicted to increase over the next M frames may be estimated according to the motion vector between the frames. Thus, the total amount of data per frame transmitted from the server device 10 to the client terminal 30 may be more likely decreased, compared to a case of using frequently-updated regions defined according to their update frequencies in the past frames up to the current frame t.

Referring back to FIG. 1, a segmenter 14h is a processor that segments a video conversion region.

In one embodiment, the segmenter 14h calculates the size, that is, the area, of a video conversion region based on the attribute information on the video conversion region set by the video conversion region setter 14g. Then, the segmenter 14h determines the processing volume per CPU core based on the number of CPU cores implementing the encoder 14m to be described later and the size of the video conversion region. The segmenter 14h then determines whether or not the size of the video conversion region is equal to or smaller than a predetermined threshold, which is for example the processing volume per CPU core. When the size of the video conversion region is equal to or smaller than the predetermined threshold, it may be estimated that the entire video conversion region may be encoded by the capability of one CPU core implementing the encoder 14m to be described later. Then, there is no point in incurring overhead involved in segmentation of the video conversion region for video compression coding. Thus, the segmenter 14h sets the number of segments of the video conversion region to “one” to avoid overhead involved in segmentation of the video conversion region for video compression coding. When, on the other hand, the size of the video conversion region exceeds the predetermined threshold, it is determined that the size of the video conversion region is beyond the capability of one CPU core implementing the encoder 14m to be described later. In this case, the video conversion region is segmented.

Specifically, the segmenter 14h first determines the number of segments of the video conversion region based on the size of the video conversion region and the processing volume per CPU core. For example, the segmenter 14h determines the number of segments according to the following segment number calculation formula: the number of segments=(the size of the video conversion region×the average processing time)/the processing volume per CPU core. The average processing time in the above segment number calculation formula is the average time it takes, per frame, to perform video compression on each unit area. For example, the segmenter 14h may calculate the average processing time by measuring the time it takes for the CPU cores of the encoder 14m to be described later to perform video compression on a certain region, and normalizing the measured time using the size of the certain region and the number of frames over which the video compression has been performed by CPU cores.

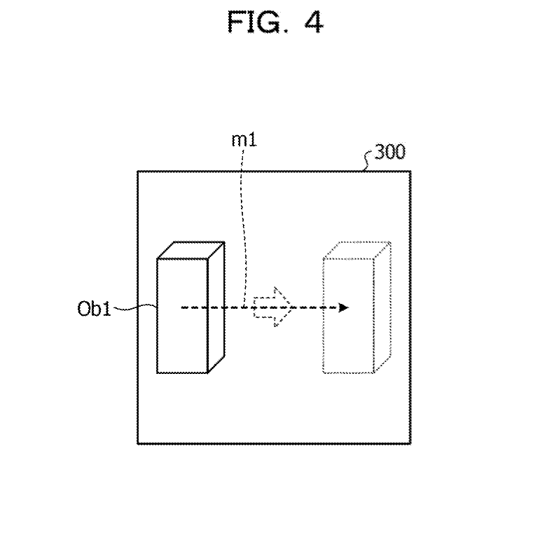

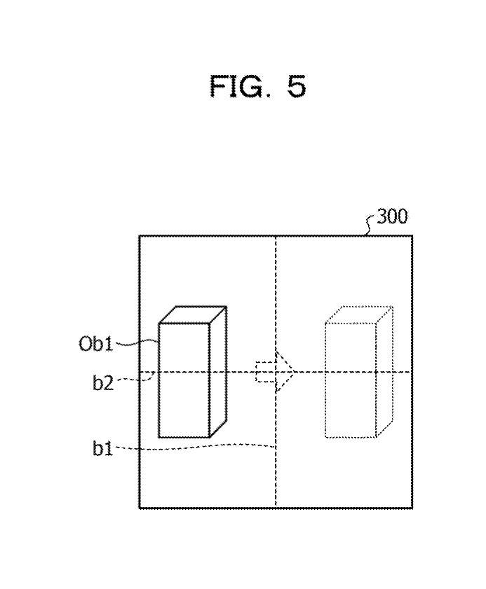

Based on the number of segments of the video conversion region thus determined and the motion vector calculated by the video conversion region setter 14g, the segmenter 14h determines the shape and size of the segments of the video conversion region. Specifically, the segmenter 14h determines the size of each segment by dividing the area of the video conversion region by the number of segments, and sets a border line or lines for segmenting the video conversion region according to the motion direction defined by the motion vector described earlier. When the difference between the motion direction and the horizontal direction is within a predetermined range, the segmenter 14h may set a border line to the horizontal direction. The segmenter 14h may set a border line to the horizontal direction when, for example, the vertical motion distance calculated in the motion vector calculation is equal to or smaller than a predetermined threshold, for example, the minimum segmentation size/2. Similarly, when the difference between the motion direction and the vertical direction is within a predetermined range, the segmenter 14h may set a border line to the vertical direction. The segmenter 14h may set a border line to the vertical direction when, for example, the horizontal motion distance calculated in the motion vector calculation is equal to or smaller than a predetermined threshold, for example, the minimum segmentation size/2. After setting the segmentation border line as above, the segmenter 14h segments the video conversion region according to the border line(s).

<Limits of the Existing Technique> FIGS. 4 and 5 are diagrams illustrating an example of a desktop screen. In the example illustrated in FIGS. 4 and 5, an object Ob1, such as a CAD three-dimensional model, is moved rightward on a desktop screen 300 by a mouse event. FIG. 4 depicts the desktop screen 300 before segmentation, while FIG. 5 depicts the desktop screen 300 segmented into four regions. To perform video compression coding on the desktop screen 300, inter-frame prediction is used to find the same direction as the direction of the mouse event as a motion vector m1. In the above existing technique, the desktop screen 300 may be segmented into four regions by a border line b1 and a border line b2, as illustrated in FIG. 5. The desktop screen 300 is thus segmented by the border line b1 in a direction orthogonal to the motion vector m1, which makes it impossible to detect the motion vector m1. As a result, motion compensation does not function effectively, and compression efficiency decreases consequently.

### Segmentation According to the Present Embodiment (1)

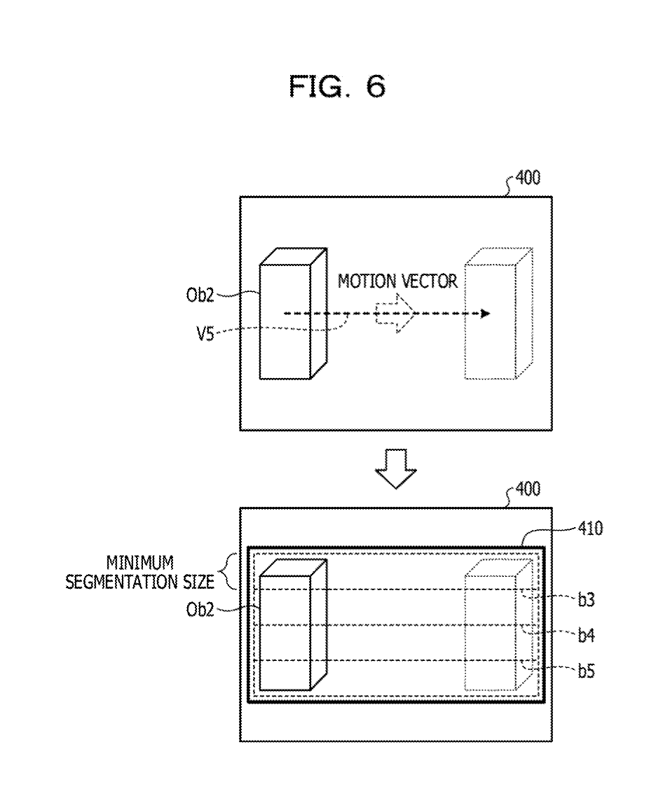

FIG. 6 is a diagram illustrating an example of a desktop screen. In the example illustrated in FIG. 6, an object Ob2, such as a CAD three-dimensional model, is moved rightward on a desktop screen 400 by a mouse event. The upper part of FIG. 6 depicts the desktop screen 400 before segmentation, while the lower part of FIG. 6 depicts the desktop screen 400 after segmentation. Assuming that the video conversion region setter 14g calculates a motion vector V5 and sets a video conversion region 410 on the desktop screen 400, border lines b3, b4, and b5 are set in the video conversion region 410 according to the motion direction defined by the motion vector V5, namely, a rightward direction. These border lines b3, b4, and b5 segment the video conversion region 410 into four segments in a direction parallel to the motion vector; thus, the motion vector may be detected during video compression. As a result, motion compensation effectively functions, avoiding decrease in compression efficiency.

### Segmentation According to the Present Embodiment (2)

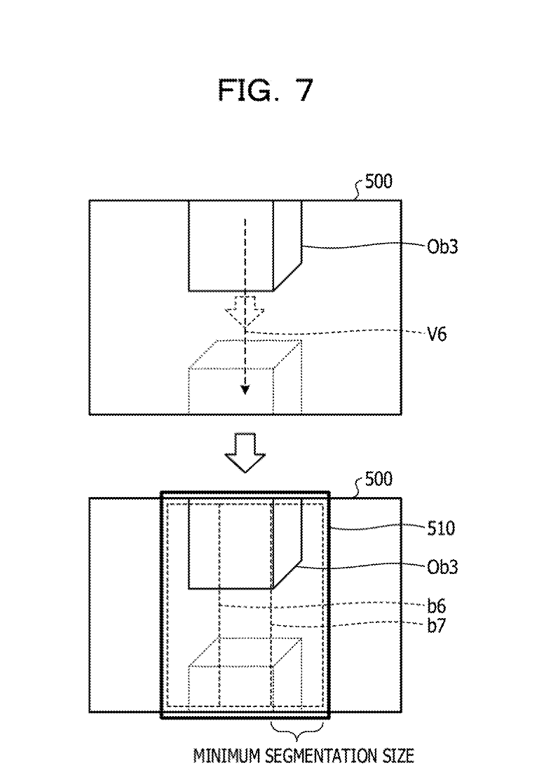

FIG. 7 illustrates an example of a desktop screen. In the example illustrated in FIG. 7, an object Ob3, such as a CAD three-dimensional model, is moved downward on a desktop screen 500 by a mouse event. The upper part of FIG. 7 depicts the desktop screen 500 before segmentation, while the lower part of FIG. 7 depicts the desktop screen 500 after segmentation. Assuming that the video conversion region setter 14g calculates a motion vector V6 and sets a video conversion region 510 on the desktop screen 500, border lines b6 and b7 are set in the video conversion region 510 according to the motion direction defined by the motion vector V6, namely a downward direction. These border lines b6 and b7 segment the video conversion region 510 into three segments in a direction parallel to the motion vector; thus, the motion vector may be detected during video compression. As a result, motion compensation effectively functions, avoiding decrease in compression efficiency.

### Segmentation According to the Present Embodiment (3)

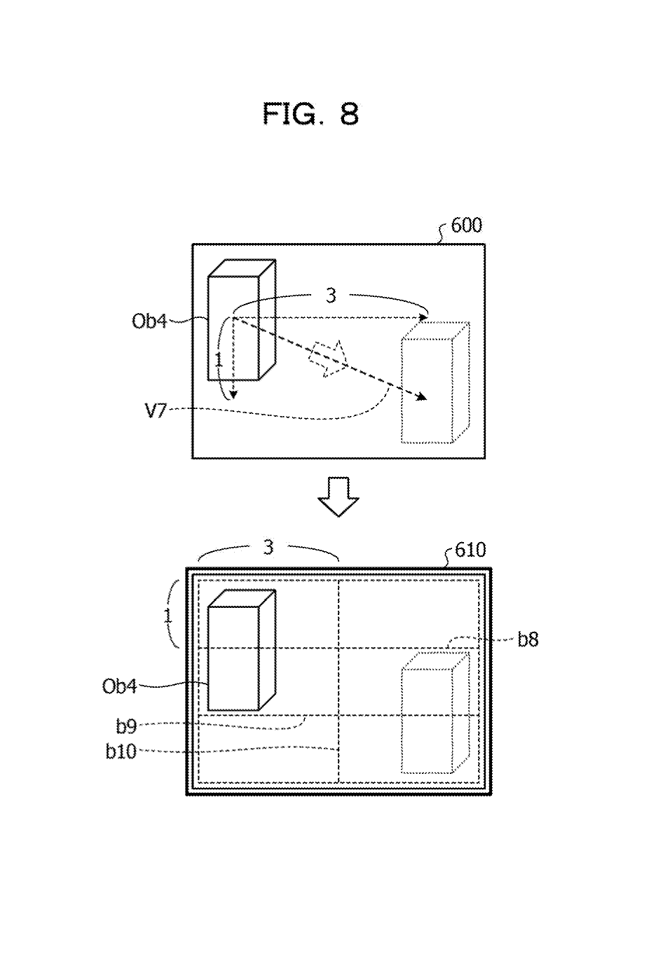

FIG. 8 illustrates an example of a desktop screen. In the example illustrated in FIG. 8, an object Ob4, such as a CAD three-dimensional model, is moved obliquely to the lower right on a desktop screen 600 by a mouse event. The upper part of FIG. 8 depicts the desktop screen 600 before segmentation, while the lower part of FIG. 8 depicts the desktop screen 600 after segmentation. Assuming that the video conversion region setter 14g calculates a motion vector V7 and sets a video conversion region 610 on the desktop screen 600, border lines b8 to b10 are set in the video conversion region 610 such that the aspect ratio of each segment of the video conversion region 610 may be the same as the ratio between the vertical component and the horizontal components decomposed from the motion vector V7, which is 1:3 in this example. These border lines b8 to b10 segment the video conversion region 610 into six segments such that the motion vector may be included in the segments as much as possible; thus, the motion vector is more likely detected during video compression, compared to a case where the video conversion region is segmented in a direction orthogonal to the motion vector. As a result, motion compensation effectively functions, avoiding decrease in compression efficiency.

Referring back to FIG. 1, a transmission controller 14j is a processor that controls transmission of videos and still images.

In one aspect, the transmission controller 14j controls transmission of still images as follows. Specifically, when the video conversion determiner 14e has determined to perform video conversion, the transmission controller 14j selects one of updated regions generated by the screen generator 14b. Then, the transmission controller 14j determines whether the selected updated region is outside a video conversion region set by the video conversion region setter 14g. When the updated region is not outside the video conversion region, the transmission controller 14j does not cause the first image transmitter 14k to transmit an image of the updated region. When, on the other hand, the updated region is outside the video conversion region, the transmission controller 14j causes the first image transmitter 14k to transmit an image of the updated region to the client terminal 30. The transmission controller 14j repeats the above transmission control until all the updated regions generated by the screen generator 14b are selected. If the video conversion determiner 14e determines not to perform video conversion, the transmission controller 14j causes the first image transmitter 14k to transmit each of the updated regions generated by the screen generator 14b to the client terminal 30.

In another aspect, the transmission controller 14j controls video transmission as follows. Specifically, when the video conversion determiner 14e determines to perform video conversion, the transmission controller 14j assigns and inputs segments of the video conversion region segmented by the segmenter 14h to CPU cores of the encoder 14m to be described below.

The encoder 14m is a processor that performs encoding.

In one embodiment, the encoder 14m is implemented by multiple central processing unit (CPU) cores and may thereby perform video compression coding with the CPU cores in parallel. Specifically, using the CPU cores in parallel, the encoder 14m encodes segments of a video conversion region that are assigned to the CPU cores. Examples of usable encoding schemes include MPEG standards, such as MPEG-2 and MPEG-4, or Motion JPEG.

The first image transmitter 14k is a processor that transmits, to the client terminal 30, an image of an updated region generated by the screen generator 14b and attribute information on the updated region. For example, the RFB protocol used in VNC is employed as the communications protocol for this transmission of images of updated regions.

The second image transmitter 14n is a processor that transmits, to the client terminal 30, an encoded image of each segment of a video conversion region, obtained by the encoder 14m. For example, the Real-time Transport Protocol (RTP) may be employed as the communications protocol for this transmission of encoded images.

The OS execution unit 11a, the application program execution unit 11b, the graphics driver 12, and the server-side remote screen control unit 14 may be implemented as follows. For example, to implement a certain one of the above processors, a central processor such as a CPU loads a process for achieving the same function as the certain processor into the memory, and executes the process. These processors do not have to be implemented by a central processor, but may be implemented by a micro processing unit (MPU), instead. In addition, the above-described processors may be implemented by hard wired logic.

<Configuration of the Client Terminal> Next, the configuration of the client terminal according to the present embodiment is described. As illustrated in FIG. 1, the client terminal 30 includes an input unit 31, the display unit 32, and a client-side remote screen controller 33. The client terminal 30 in the example illustrated in FIG. 1 further includes, besides the function parts illustrated in FIG. 1, various other function units that a known computer has, for example, an audio output unit.

The input unit 31 is an input device that receives various kinds of information, such as an instruction inputted and handled by the client-side remote screen controller 33 to be described later, and is, for example, a keyboard, a mouse, and/or the like. The display unit 32 to be described below also implements a function as a pointing device in cooperation with the mouse.

The display unit 32 is a display device that displays various kinds of information such as a desktop screen sent from the server device 10, and is, for example, a monitor, a touch panel, and/or the like.

The client-side remote screen controller 33 is a processor that receives, through the client-side remote screen control app, the remote screen control service provided by the server device 10. As illustrated in FIG. 1, the client-side remote screen controller 33 includes an operation information notifier 33a, a first image receiver 33b, a first display controller 33c, a second image receiver 33d, a decoder 33e, and a second display controller 33f.

The operation information notifier 33a is a processor that notifies the server device 10 of operation information acquired by the input unit 31. Examples of the operation information notified of by the operation information notifier 33a include a mouse event such as a right/left click, a double click, or a drag, the coordinates of the mouse cursor on the desktop screen, and the amount of rotation of the mouse wheel. Examples of the operation information further include the type of a key pressed on the keyboard.

The first image receiver 33b is a processor that receives an image of an updated region and attribute information on the updated region sent from the first image transmitter 14k of the server device 10. The first image receiver 33b also receives attribute information on a video conversion region sent from the first image transmitter 14k of the server device 10.

The first display controller 33c is a processor that displays, on the display unit 32, an image of an updated region received by the first image receiver 33b. As an example, the first display controller 33c displays a bitmap image of an updated region at a region on the screen of the display unit 32 which corresponds to the position and size indicated by the attribute information on the updated region received by the first image receiver 33b. When attribute information on a video conversion region is received by the first image receiver 33b, the first display controller 33c specifies a region on the screen of the display unit 32 which corresponds to the position and size of the video conversion region indicated by the attribute information on the video conversion region and sets this region as a blank region where no bitmap image is to be displayed.

The second image receiver 33d is a processor that receives an encoded image of each segment of a video conversion region sent from the second image transmitter 14n of the server device 10. The second image receiver 33d also receives attribute information on the video conversion region transmitted from the second image transmitter 14n of the server device 10.

The decoder 33e is a processor that decodes an encoded image of each segment of a video conversion region received by the second image receiver 33d. The decoder 33e may also be implemented by multiple CPU cores, and thereby may decode encoded images of the segments of the video conversion region in parallel. The decoder 33e employs a decoding scheme corresponding to the encoding scheme employed by the server device 10.

The second display controller 33f is a processor that causes the display unit 32 to display a decoded image of each segment of a video conversion region based on the attribute information on the video conversion region received by the second image receiver 33d, the decoded image being obtained by the decoder 33e. As an example, the second display controller 33f displays decoded images of a video conversion region at a region on the screen of the display unit 32 which corresponds to the position and size of the video conversion region indicated by the attribute information on the video conversion region.

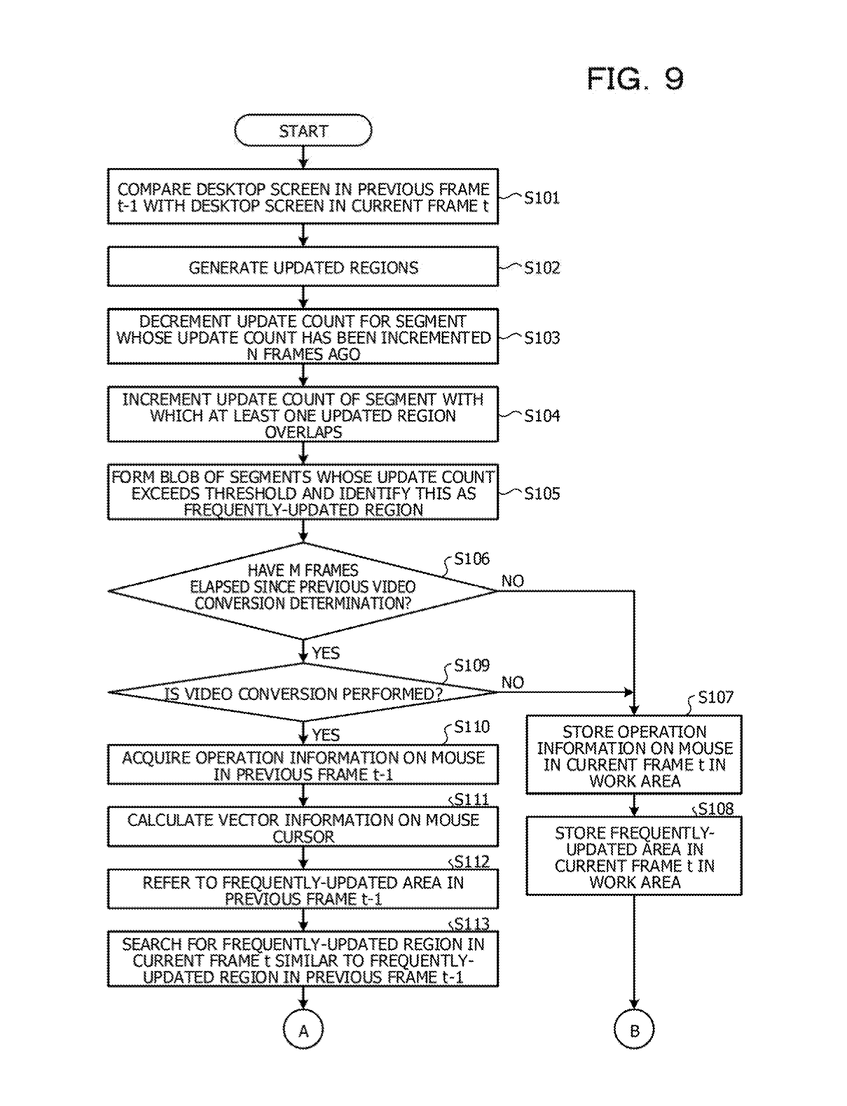

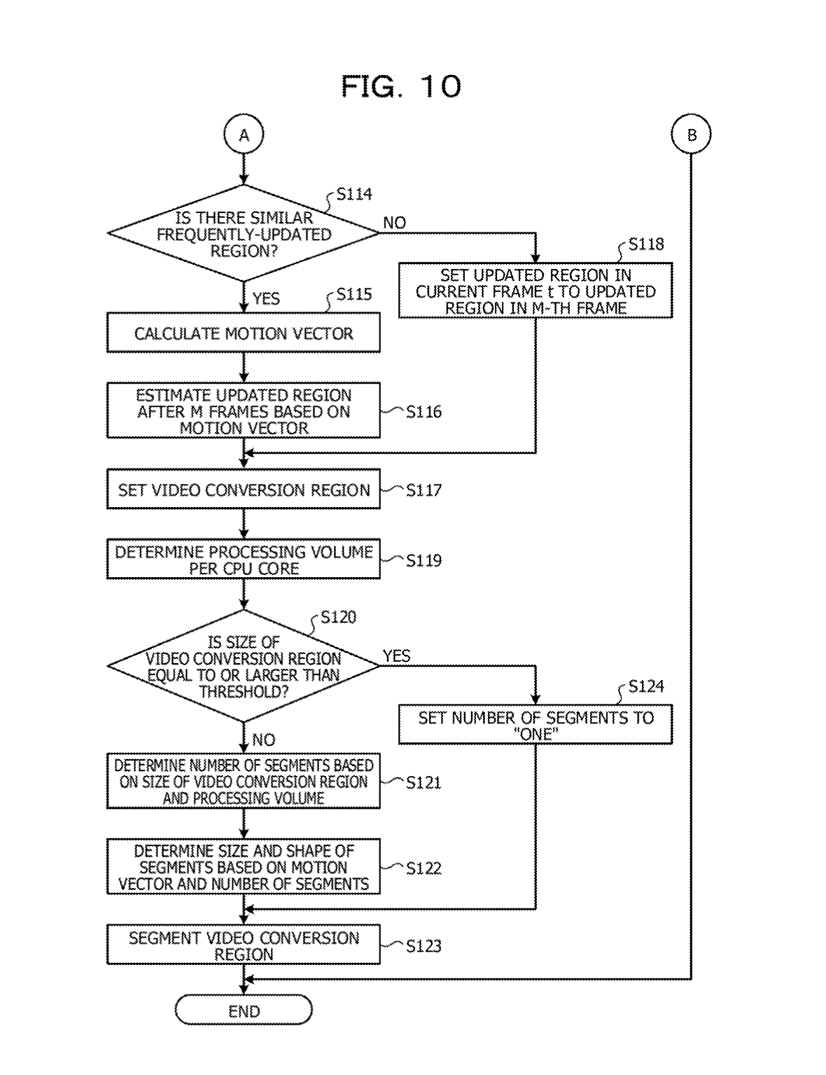

The processors in the client-side remote screen controller 33 may be implemented as follows. For example, to implement a certain one of the processors, a central processor such as a CPU loads a process for achieving the same function as the certain processor into the memory, and executes the process. These processors do not have to be implemented by a central processor, but may be implemented by an MPU, instead. In addition, the above-described processors may be implemented by hard wired logic.

<Processing Procedures> Next, the procedures of processing performed by the thin client system 1 according to the present embodiment are described. Herein, descriptions are given of (1) segmentation processing, (2) first transmission control processing, and (3) second transmission control processing, which are performed by the server device 10.

<(1) Segmentation Processing> FIGS. 9 and 10 are a flowchart of the segmentation processing according to Embodiment 1. In one example, this processing is repeated every time the period for updating desktop screen, for example, every 30 fps, elapses.

As illustrated in FIG. 9, the screen generator 14b compares bitmap data on the desktop screen in the previous frame t−1 saved in the internal memory, with bitmap data on the desktop screen in the current frame t stored in the framebuffer 13 (Step S101). The screen generator 14b then performs labeling on pixels that differ in pixel value between the two desktop screens, forms a rectangular blob containing the pixels with the same label as an updated region, and thereby generates a packet of the updated region (Step S102).

Thereafter, the update frequency measurer 14c discards the oldest measurement results from the update count map described earlier by decrementing the update count for a mesh segment the update count of which has been incremented N frames ago (Step S103). Then in the update count map, the update frequency measurer 14c increments the update count for each mesh segment with which a predetermined number or more of the updated regions generated in Step S102 overlap (Step S104).

For the mesh segments in the update count map, the frequently-updated region identifier 14d performs labeling on segments the update count of which exceeds a predetermined threshold, and identifies a blob of segments with the same label as a frequently updated region (Step S105).

When a predetermined number of frames (M frames, where M is a natural number) have not elapsed yet since the previous video conversion determination (No in Step S106), the vector information calculator 14f saves, in the work area of the internal memory, the coordinates of the mouse cursor in the current frame t acquired by the operation information acquirer 14a (Step S107). Then, the video conversion region setter 14g saves, in the work area of the internal memory, attribute information on the frequently-updated region in the current frame t identified in Step S105 (Step S108).

When, on the other hand, the predetermined number of frames (M frames) have elapsed since the previous video conversion determination (Yes in Step S106), the video conversion determiner 14e determines whether to perform video conversion based on whether a frequently-updated region has been identified in Step S105 (Step S109).

When the video conversion determiner 14e determines not to perform video conversion (No in Step S109), the vector information calculator 14f saves, in the work area of the internal memory, the coordinates of the mouse cursor in the current frame t acquired by the operation information acquirer 14a (Step S107). Then, the video conversion region setter 14g saves, in the work area of the internal memory, attribute information on the frequently-updated region in the current frame t identified in Step S105 (Step S108).

When, on the other hand, the video conversion determiner 14e determines to perform video conversion (YES in Step S109), the vector information calculator 14f reads the coordinates of the mouse cursor in the previous frame t−1 saved in the internal memory (Step S110). Based on the coordinates of the mouse cursor in the previous frame t−1 read in Step S110 and the coordinates of the mouse cursor in the current frame t acquired by the operation information acquirer 14a, the vector information calculator 14f calculates, as vector information, the direction and amount of motion of the mouse cursor (Step S111).

Then, the video conversion region setter 14g reads the attribute information on the frequently-updated region in the previous frame t−1 saved in the internal memory (Step S112). Then, using the vector information on the mouse cursor calculated in Step S111, the video conversion region setter 14g searches for a frequently-updated region in the current frame t which has been identified by the frequently-updated region identifier 14d and is similar in shape to the frequently-updated region in the previous frame t−1 read in Step S112 (Step S113).

Moving on to the flowchart illustrated in FIG. 10, when successfully finding the frequently-updated region in the current frame t similar in shape to the frequently-updated region in the previous frame t−1 (Yes in Step S114), the video conversion region setter 14g determines the motion direction and motion distance of the frequently-updated region from the previous frame t−1 to the current frame t as a motion vector (Step S115).

The video conversion region setter 14g then sets a starting point at an updated region in the current frame t, and sets the motion direction defined by the motion vector as a target direction. Then, the video conversion region setter 14g moves the updated region in the current frame t M times the motion distance defined by the motion vector, that is, from the current frame t to the M-th frame after which the next video conversion determination is made. The video conversion region setter 14g thereby estimates a predicted updated region where the updated region in the current frame t is predicted to be located in the M-th frame (Step S116).

The video conversion region setter 14g then specifies segments that overlap with at least one of the updated region in the current frame t, the predicted updated region where the updated region in the current frame t is predicted to be located in the M-th frame, and the track of the updated region in the current frame t moving from the current frame t to the M-th frame, and sets a blob of these segments as a video conversion region (Step S117).

When, on the other hand, failing to find the frequently-updated region in the current frame t similar in shape to the frequently-updated region in the previous frame t−1 (No in Step S114), the video conversion region setter 14g sets the motion vector between the frames to “zero”, and thereby sets the updated region in the current frame t as the predicted updated region where the updated region in the current frame t is predicted to be located in the M-th frame (Step S118). In this case, the video conversion region setter 14g sets the updated region in the current frame t as a video conversion region (Step S117).

Next, the segmenter 14h calculates the size of the video conversion region set in Step S117 based on the attribute information on the video conversion region, and determines processing volume per CPU core based on the size of the video conversion region and the number of CPU cores implementing the encoder 14m (Step S119). The segmenter 14h then determines whether the size of the video conversion region is equal to or smaller than a predetermined threshold which is for example the processing volume per CPU core (Step S120).

When the size of the video conversion region is equal to or smaller than the predetermined threshold (Yes in Step S120), it may be estimated that the entire video conversion region may be encoded with the capability of one CPU core implementing the encoder 14m. In this case, there is no point in incurring overhead involved in segmentation of the video conversion region for video compression coding. Thus, the segmenter 14h sets the number of segments of the video conversion region to “one” (Step S124), and proceeds to Step S123.

When, on the other hand, the size of the video conversion region exceeds the predetermined threshold (No in Step S120), it may be determined that the size of the video conversion region is beyond the capability of one CPU core implementing the encoder 14m. In this case, segmentation of the video conversion region is performed.

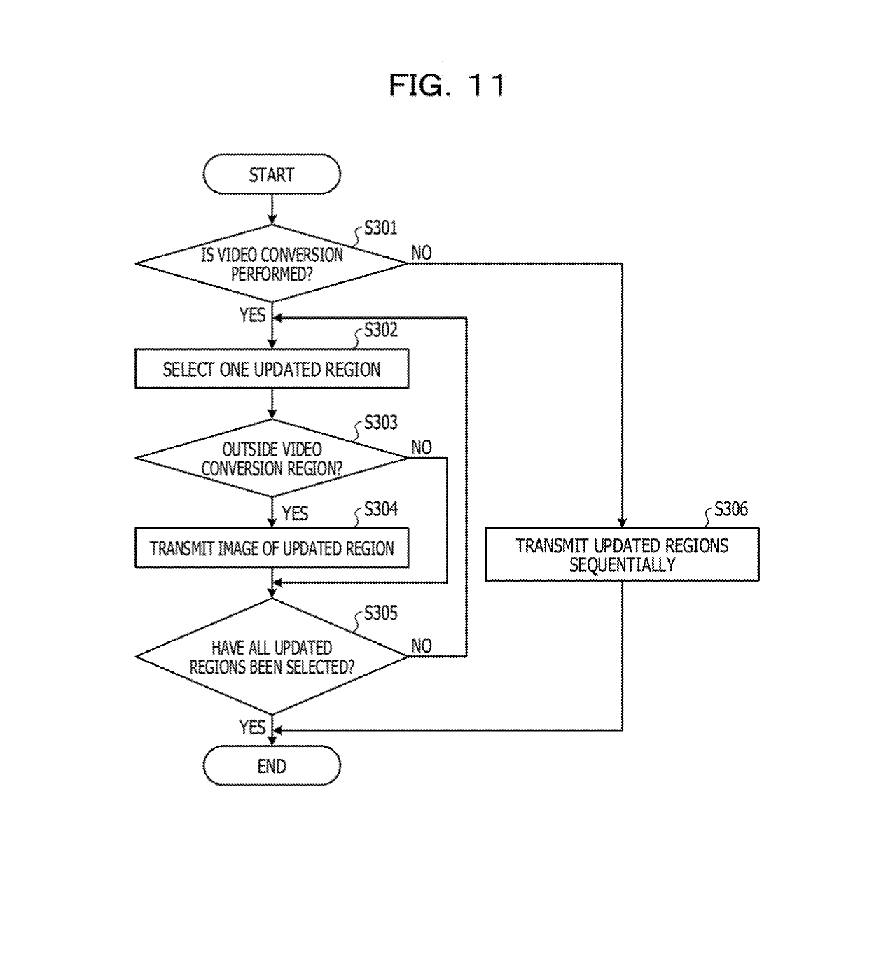

Specifically, the segmenter 14h first determines the number of segments of the video conversion region based on the size of the video conversion region and the processing volume per CPU core (Step S121). The segmenter 14h then determines the shape and size of each segment of the video conversion region, based on the number of segments of the video conversion region determined in Step S121 and the motion vector calculated in Step S115 (Step S122). The segmenter 14h then segments the video conversion region according to the segmentation shape and size determined in Step S122 (Step S123). The processing thereby ends.

<(2) First Transmission Control Processing> FIG. 11 is a flowchart illustrating the procedures of first transmission control processing according to Embodiment 1. This processing is, in one example, repeated every time the screen update period elapses. As illustrated in FIG. 11, when the video conversion determiner 14e determines to perform video conversion (Yes in Step S301), the transmission controller 14j selects one of updated regions generated by the screen generator 14b (Step S302).

The transmission controller 14j then determines whether the updated region selected in Step S302 is outside the video conversion region set by the video conversion region setter 14g (Step S303). When the updated region is not outside the video conversion region (No in Step S303), the transmission controller 14j proceeds to Step S305 without causing the first image transmitter 14k to transmit an image of the updated region.

When, on the other hand, the updated region is outside the video conversion region (Yes in Step S303), the transmission controller 14j causes the first image transmitter 14k to transmit an image of the updated region to the client terminal 30 (Step S304).

The above-described processing from Steps S302 to S304 is repeated (No in Step S305) until all the updated regions generated by the screen generator 14b are selected. Once all the updated regions generated by the screen generator 14b are selected (Yes in Step 305), the processing ends.

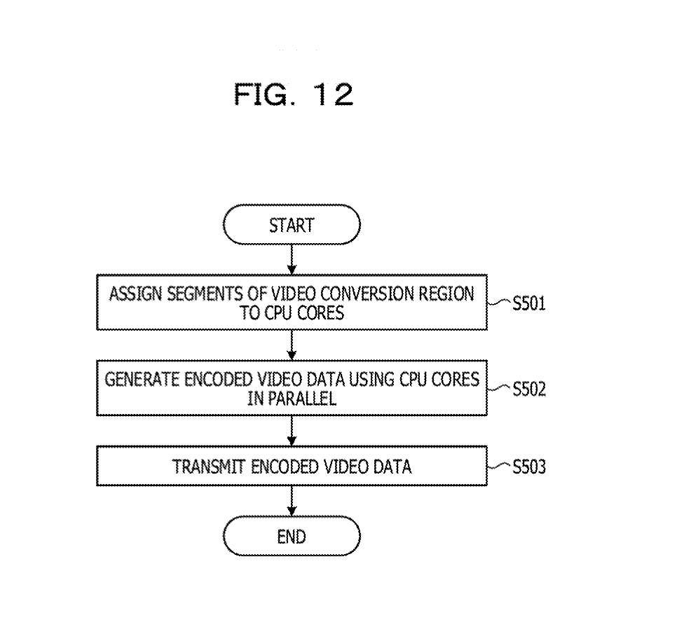

When the video conversion determiner 14e does not determine to perform video conversion (No in Step S301), the transmission controller 14j causes the first image transmitter 14k to sequentially transmit images of the updated regions generated by the screen generator 14b (Step (S306), and the processing ends.

<(3) Second Transmission Control Processing> FIG. 12 is a flowchart illustrating the procedures of second transmission control processing according to Embodiment 1. This processing is, in one example, executed when the video conversion determiner 14e determines to perform video conversion. As illustrated in FIG. 12, the transmission controller 14j assigns and inputs segments of a video conversion region obtained by the segmenter 14h to the CPU cores of the encoder 14m (Step S501).

Using its CPU cores in parallel, the encoder 14m encodes the segments of the video conversion region assigned to the CPU cores of the encoder 14m in Step S501 and thereby obtains encoded images (Step S502).

Thereafter, the second image transmitter 14n transmits, to the client terminal 30, the encoded images of the respective segments of the video conversion region obtained by the encoder 14m (Step S503), and the processing thus ends.

<One Aspect of Advantageous Effects> As described above, the server device 10 according to the present embodiment segments a video conversion region on a desktop screen that the server device 10 transmits to the client terminal 30, along border lines set according to a direction in which an updated region moves in the video conversion region. Thus, the server device 10 according to the present embodiment may avoid decrease in the compression efficiency for a video conversion region on the desktop screen.

### Embodiment 2

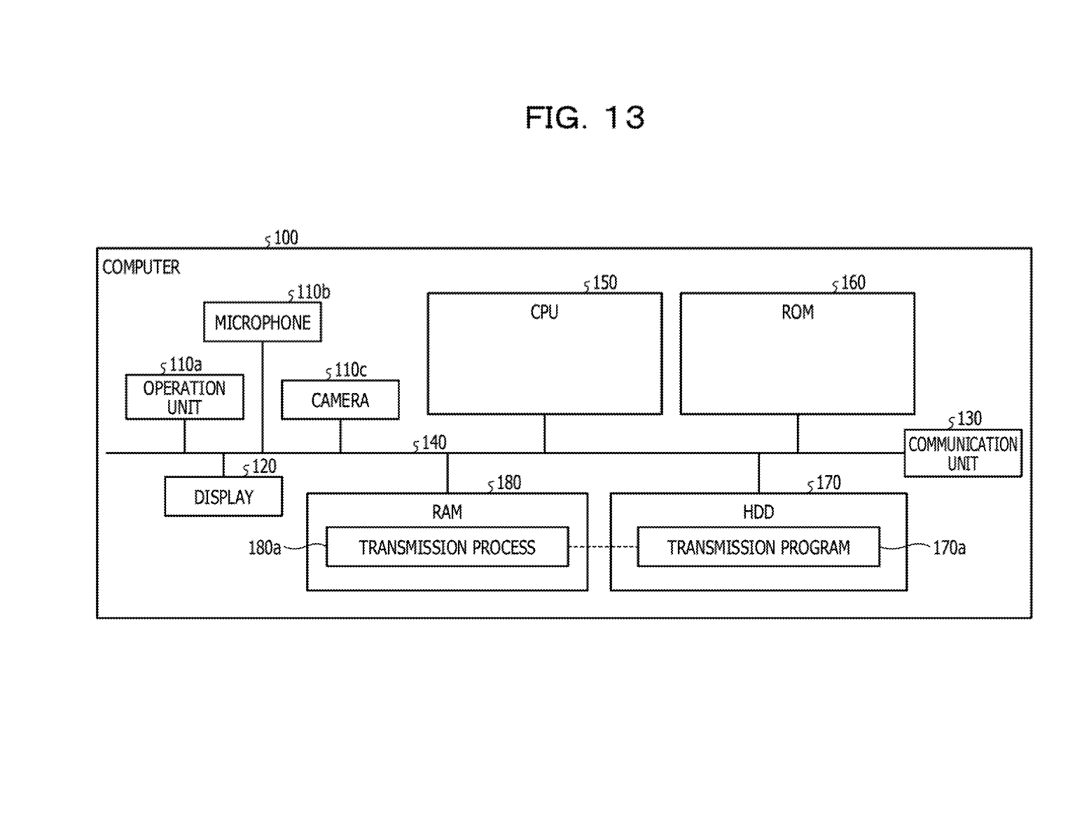

An embodiment of the disclosed device has been described above, but the present disclosure may be implemented in various ways other than the foregoing embodiment. The following description provides such other embodiments of the disclosed device.

<Distribution and Integration> The components of the devices illustrated in the drawings do not have to be configured physically as illustrated in the drawings. To be more specific, how the components of the devices are distributed or integrated is not limited to the mode illustrated in the drawings, and all or some of the components may be distributed or integrated in any unit functionally or physically according to various factors such as workload and usage status. For example, part of the processors of the server-side remote screen control unit 14 may be implemented by an external device of the server device 10 connected to the server device 10 over a network. Moreover, the functions of the image processing apparatus described above may be implemented by causing some of the processors of the server-side remote screen control unit 14 to be implemented by another device which is connected to the server device 10 over a network and cooperates with the server device 10.

<Transmission Program> The various types of processing described in the above embodiment may be performed by a computer, such as a personal computer or a workstation, executing prepared programs. With reference to FIG. 13, the following description gives an example of a computer executing a transmission program for achieving the same functions as those described in the above embodiment.

FIG. 13 is a diagram illustrating the hardware configuration of a computer according to Embodiments 1 and 2 that executes a transmission program. As illustrated in FIG. 13, a computer 100 includes an operation unit 110a, a microphone 110b, a camera 110c, a display 120, and a communication unit 130. The computer 100 further includes a CPU 150, a ROM 160, an HDD 170, and a RAM 180. These parts 110 to 180 are connected to one another via a bus 140.

As illustrated in FIG. 13, the HDD 170 stores a transmission program 170a that achieves the same function as that achieved by the server-side remote screen control unit 14 described in Embodiment 1. The transmission program 170a may be distributed or integrated, like the components of the server-side remote screen control unit 14 illustrated in FIG. 1. In other words, the HDD 170 does not have to store all the data described in Embodiment 1, and only has to store data to be used in a transmission process.

In such an environment, the CPU 150 reads the transmission program 170a from the HDD 170 and loads the transmission program 170a into the RAM 180. As a result, the transmission program 170a functions as a transmission process 180a, as illustrated in FIG. 13. The transmission process 180a loads various kinds of data read from the HDD 170 into the RAM 180 on its storage region allocated to the transmission process 180a. Using the various kinds of data thus loaded, the transmission process 180a executes various kinds of processing. Examples of the processing executed by the transmission process 180a include the processing illustrated in FIGS. 9 to 11. Not all the processors described in Embodiment 1 have to be implemented by the CPU 150. A processor responsible for certain processing to be executed may be implemented virtually.

The transmission program 170a does not have to be stored in the HDD 170 or the ROM 160 in advance. For example, the transmission program 170a may be stored in a portable physical medium designed to be inserted into the computer 100, such as a flexible disk (FD), a CD-ROM, a DVD, a magneto optical disk, or an IC card, so that the computer 100 may acquire the transmission program 170a from such a transportable physical medium and execute the transmission program 170a. Alternatively, the transmission program 170a may be stored in, for example, another computer or server device connected to the computer 100 via public lines, the Internet, a LAN, a WAN, or the like, so that the computer 100 may acquire the transmission program 170a from that computer or server device and execute the transmission program 170a.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An apparatus for image processing comprising:
a memory configured to store display screen data to be displayed on a display device; and
a processor coupled to the memory and configured to
execute an acquisition process that includes acquiring a position of a pointer of an input device,
execute an update process that includes updating the display screen data stored in the memory,
execute an identifying process that includes identifying a region updated at an update frequency equal to or larger than a threshold between frames of the display screen data stored in the memory,
execute a search process that includes, based on a track of the position of the pointer, searching for a motion direction of the region updated at the update frequency equal to or larger than the threshold,
execute a segmentation process that includes segmenting the region updated at the update frequency equal to or larger than the threshold into segments along a border line set therein according to the motion direction, and
execute a compression process that includes assigning a plurality of processes for performing video compression on images of the segments of the region to a plurality of processors, respectively, and causing the plurality of processors to perform the video compression processes in parallel.

2. The apparatus according to claim 1,
wherein the search process includes searching for the motion direction and a motion distance of the region updated at the update frequency equal to or larger than the threshold, based on the track of the position of the pointer, and
the segmentation process includes segmenting, based on the motion direction and the motion distance, a region corresponding to a moving range in which the region updated at the update frequency equal to or larger than the threshold moves over a predetermined number of frames.

3. The apparatus according to claim 2,
wherein the segmentation process includes determining the number of segments of the region corresponding to the moving range based on the area of the region corresponding to the moving range and the number of the plurality of processors.

4. The apparatus according to claim 1,
wherein the processor is configured to execute a transmission process that includes transmitting video compression data on the images of the respective segments.

5. The apparatus according to claim 1,
wherein the acquisition process causes the processor to acquire a position of a pointer of the input device via a communication network.

6. The apparatus according to claim 4,
wherein the transmission process causes the processor to transmit video compression data on the images of the respective segments, using RFB (Remote Frame Buffer) protocol.

7. The apparatus according to claim 4,
wherein the processor is configured to execute a remote screen control application which controls a desktop screen to be displayed on a client terminal connected to the apparatus via a communication network,
the remote screen control application causes the processor to execute the acquisition process, the update process, the identifying process, the search process, the segmentation process, the compression process, and the transmission process.

8. A method for image processing, the method comprising:
executing, by a computer, an acquisition process that includes acquiring a position of a pointer of an input device;
executing, by the computer, an update process that includes updating display screen data to be displayed on a display device, the display screen data being stored in a memory;
executing, by the computer, an identifying process that includes identifying a region updated at an update frequency equal to or larger than a threshold between frames of the display screen data stored in the memory;
executing, by the computer, a search process that includes searching, based on a track of the position of the pointer, for a motion direction of the region updated at the update frequency equal to or larger than the threshold;
executing, by the computer, a segmentation process that includes segmenting the region updated at the update frequency equal to or larger than the threshold into segments along a border line set therein according to the motion direction; and
executing, by the computer, a compression process that includes assigning a plurality of processes for performing video compression on images in the segments of the region to a plurality of processors, respectively, and causing the plurality of processors to perform the video compression processes in parallel.

9. The method according to claim 8,
wherein the search process includes searching for the motion direction and a motion distance of the region updated at the update frequency equal to or larger than the threshold, based on the track of the position of the pointer, and
the segmentation process includes segmenting, based on the motion direction and the motion distance, a region corresponding to a moving range in which the region updated at the update frequency equal to or larger than the threshold moves over a predetermined number of frames.

10. The method according to claim 9,
wherein the segmentation process includes determining the number of segments of the region corresponding to the moving range based on the area of the region corresponding to the moving range and the number of the plurality of processors.

11. The method according to claim 8, the method further comprising:
executing, by the computer, a transmission process that includes transmitting video compression data on the images of the respective segments.

12. The method according to claim 8,
wherein the acquisition process causes the computer to acquire a position of a pointer of the input device via a communication network.

13. The method according to claim 11,
wherein the transmission process causes the computer to transmit video compression data on the images of the respective segments, using RFB (Remote Frame Buffer) protocol.

14. The method according to claim 11, the method further comprising:
executing a remote screen control application which controls a desktop screen to be displayed on a client terminal connected to the computer via a communication network,
wherein the remote screen control application causes the computer to execute the acquisition process, the update process, the identifying process, the search process, the segmentation process, the compression process, and the transmission process.

15. A non-transitory computer-readable medium for storing computer-executable program that cause a processor to execute a process, the process comprising:
executing an acquisition process that includes acquiring a position of a pointer of an input device;
executing an update process that includes updating display screen data to be displayed on a display device, the display screen data being stored in a memory;
executing an identifying process that includes identifying a region updated at an update frequency equal to or larger than a threshold between frames of the display screen data stored in the memory;
executing a search process that includes searching, based on a track of the position of the pointer, for a motion direction of the region updated at the update frequency equal to or larger than the threshold;
executing a segmentation process that includes segmenting the region updated at the update frequency equal to or larger than the threshold into segments along a border line set therein according to the motion direction; and
executing a compression process that includes assigning a plurality of processes for performing video compression on images in the segments of the region to a plurality of processors, respectively, and causing the plurality of processors to perform the video compression processes in parallel.

16. The non-transitory computer-readable medium according to claim 15,
wherein the search process includes searching for the motion direction and a motion distance of the region updated at the update frequency equal to or larger than the threshold, based on the track of the position of the pointer, and
the segmentation process includes segmenting, based on the motion direction and the motion distance, a region corresponding to a moving range in which the region updated at the update frequency equal to or larger than the threshold moves over a predetermined number of frames.

17. The non-transitory computer-readable medium according to claim 16,
wherein the segmentation process includes determining the number of segments of the region corresponding to the moving range based on the area of the region corresponding to the moving range and the number of the plurality of processors.

18. The non-transitory computer-readable medium according to claim 15, the process further comprising:
executing a transmission process that includes transmitting video compression data on the images of the respective segments.

19. The non-transitory computer-readable medium according to claim 18,
wherein the transmission process causes the processor to transmit video compression data on the images of the respective segments, using RFB (Remote Frame Buffer) protocol.

20. The non-transitory computer-readable medium according to claim 18, the process further comprising:
executing a remote screen control application which controls a desktop screen to be displayed on a client terminal connected to the processor via a communication network,
wherein the remote screen control application causes the processor to execute the acquisition process, the update process, the identifying process, the search process, the segmentation process, the compression process, and the transmission process.
